(19) United States
(12) Patent Application Publication
(10) Pub. No.: US 2022/0095577 A1
(43) Pub. Date: Mar. 31, 2022

(54) FREE FLOW ELECTRONIC METER

(71) Applicant: LAKTO HAYVANCILIK TEKNOLOJILERI SANAYI VE TICARET LIMITED SIRKETI, Cigli-Izmir (TR)

(72) Inventor: Basat Tomek, Cigli-Izmir (TR)

(21) Appl. No.: 17/310,775

(22) PCT Filed: Jun. 19, 2019
(86) PCT No.: PCT/TR2019/050468

§ 371 Date: Aug. 23, 2021

(51) Int. Cl. A01J 5/01; G01F 1/64; G01F 15/12

(52) U.S. Cl. CPC A01J 5/01; G01F 15/12; G01F 1/64

(57) ABSTRACT

The present disclosure is related to a free flow electronic meter, which is used in measuring the velocity and flow rate of a fluid, particularly in measuring milk yield of sheep, goat, buffalo and cattle during milking. The free flow electronic meter includes a measurement pipe wherein the velocity of the material that passes through it is measured by means of a flow rate measurement sensor. When the milk flows continuously through the measurement pipe, an air passage pipe and/or free air passage pipe prevents vacuum fluctuation that causes udder diseases. This result is reached by preventing a change of the vacuum level during milking due to increased milk flow at teat end by providing extra air passage.

### TECHNICAL FIELD

The present invention is related to a free flow electronic meter which is used for measuring the velocity and flow rate of the fluid, particularly for measuring milk yields of cattle, buffalo and small ruminants in milking systems.

The present invention is related to a free flow electronic meter which comprises a measurement pipe wherein the flow rate of the material that passes through it is measured by means of the speed measurement sensor, an air/vacuum passage pipe and/or free air passage pipe which prevents pressure fluctuation that could cause udder diseases during milking due to increased milk flow.

### PREVIOUS TECHNIQUE

It is required to measure and record milk productivity of milking animals during each milking, in both small ruminants and bovine dairy farming enterprises. Taking measurements is necessary for determining the faults made in feeding and to discover individual diseases of animals early on. Apart from this individual milk productivity, measurement is required for correct selection within the herd, to find out profitable animals, as well as determining which ones are young females to be kept in the herd, according to their mother's milk yield.

Today, in computerized herd management applications, the milk yield data collected from electronic milk meters is stored in a database and reported as it is required by farmers. The animals with low productivity are determined and reported to the user for intervention. Due to these abilities, demand for mechanical milk meters, which requires manual recording, decreases gradually.

In order to define a device as a milk meter, the most important criterion is that it should make individual milk measurement with a deviation less than 2.5%, with a certificate approved by the ICAR (International Committee of Animal Recording).

The most important criterion, in terms of animal health, is that during milking there should not be differences between the vacuum levels before and after the milk meter is in use, or if any differences exist, it shall be at levels which will not cause significant fluctuations of the vacuum level. Unfortunately, there are milk meters in the market which have measurements with precisions sufficient enough to have ICAR approval; however, they cause fluctuations in the vacuum levels during the milking process. These milk meters affect udder health negatively, causing mastitis (mammal inflammation) disease.

The measuring assembly, with a stable chamber used in the present state of the art, measures the amount by means of discharging the milk after each filling, which is filled into a double or single chamber with a predetermined volume. If the measurement chamber is not fully filled at the end of the milking process, such an amount is not included within the measurement. The amount, which is not included within the measurement, increases the proportional fault ratio because the milked amount at each session of the small ruminant is in small quantities. In addition to this, because the area required to be washed at the end of the milking is very large, the total water amount required for washing, consumes electricity due to washing with hot water and the need for chemical cleaning is very high. This both increases operating costs and negatively impacts natural sources. On the other hand, these kinds of milk meters are very sensitive to balance failures. In cases where the measurement chamber is slightly inclined to any direction, it can cause false measurements.

The tipper type milk meters are also used in the present state of the art. The portion within a measurement chamber fills up to a certain amount. Then, once a threshold is reached, the excess content of the measurement chamber spills over into another chamber determined by weight/volume ratio. The milk is filled again in the chamber once excess amount has been transferred into another chamber. This movement continues during the milking process. Each turnover calculates how much milk is milked by multiplying the meter turnover motion and chamber volume. It is a very old and simple method. In order to operate said mechanism, very big volume is required in the measurement container and it requires more water, detergent and heating energy during washing compared to a type of milk meter with a chamber. Therefore, the operating cost is high when it is washed under ideal conditions. These kinds of milk meters are required to be operated in a balance. They make many mistakes if unbalanced.

The free flow meters with electrodes are sometimes used in the present state of the art. These types of meters can have different number of electrodes depending on the model. With different heights within the measurement chamber. During the milking process, the amount of milk is determined by means of the flow rate depending on the change of the surface area of the electrode. The instant flow of milk, with increasing or decreasing levels within the chamber, comes into contact with the common electrode.

This type of meter has a low operating cost because it does not have movable parts. However, the electrodes are very sensitive to lime and milk stone; the lime adheres onto the electrodes during hot washing. During nearly every washing phase, it must also be washed with acid. Compared to other types of meters, where the application of acid washing is required to be made every 2-3 milking periods, in this type of meter the washing, it should be made after every milking and thus this increases the operating costs when compared to the other models. As the meter should be operated at full balance, it also is sensitive to balance failures.

An infrared detector milk meter, used in the present state of the art, where the area covered by the milk on the profile section where the milk passes through a determined diameter pipe is measured. Thus, the instant flow rate and the milked milk during the milking process is determined. The measuring profile section is narrow due to the insufficiency of the method used in these kinds of meters. This situation particularly causes excessive fluctuation of the vacuum level on the nipple during milking, thus, causing of udder diseases.

As a result, in order to solve the abovementioned problems, which are included within the present state of the art, the requirement for an economic, useful meter which does not cause udder diseases and due to insufficient solutions, a development in the relevant technical field is required.

### AIM OF THE INVENTION

The present invention solves all of the above-mentioned problems at the same time. Said invention is in general related to a free flow electronic meter which is used in measuring the velocity and flow rate of the fluid, particularly in measuring milk yield, of both small ruminants and cattle, during milking.

The most important aim of the invention is to enable a continuous air passage by means of another profile, while the lower profile is connected with the front collection chamber, thus eliminating vacuum fluctuations. Vacuum fluctuations cause udder diseases. Moreover, the vacuum level at the teats does not change due to the increased milk flow rate during milking.

Another aim of the invention is to measure the flow rate obtained by means of multiplying the constant cross-sectional area and velocity of the milk in the measurement pipe, therefore calculating the milked amount during the milking process without mistakes.

Another aim of the invention is to allow measuring of the electrical conductivity of the milk during milking in order to determine the udder diseases because the milk which passes through the measurement profile is foamless.

Another aim of the invention is to enable valves which can close both air feeding and measurement pipes on the meter body. These valves provide the milking cluster to be removed from the udder in an easy manner with the automatic remover, by cutting all vacuum feedings at the end of the milking process. Therefore, a further vacuum cutter valve group is not required for the automatic remover assembly. In addition, due to opening and closing of the valves during the washing process, the washing solution contacts all internal walls of the milk meter in order to be washed properly.

The structural and characteristic features of the present invention will be understood clearly by the following drawings and the detailed description made with reference to these drawings and therefore the evaluation shall be made by taking these figures and the detailed description into consideration.

### SUMMARY

In accordance with an aspect, there is provided a free flow electronic meter, which may have: at least one measurement pipe; at least one air passage pipe; at least one free air passage pipe; and at least one measurement pipe which may be connected to the at least one air passage pipe and/or at least one free air passage pipe.

The free flow electronic meter may further have: a flow rate measurement sensor, which may be located on the measurement pipe; a front collection chamber wherein the milk may be collected when it first enters; an electrical conductivity sensor, which may be located on the measurement pipe.

The free flow electronic meter may further have: a lower shutoff and/or an upper shutoff valves, wherein the lower shutoff valve may be located on the lower end of the measurement pipe, while the upper shutoff valve may be located on the air passage pipe, and may have a temperature measurement sensor. The temperature measurement sensor may be located on the measurement pipe.

### FIGURES CLARIFYING THE INVENTION

FIG. 1—is a drawing, which shows a free flow electronic meter of the present invention.

### REFERENCE NUMBERS

10. Inlet

20. Front Collection Chamber

30. Air Passage Pipe

40. Measurement Pipe

50. Free Air Passage Pipe

60. Temperature Sensor

70. Electrical Conductivity Sensor

80. Flow Rate Measurement Sensor

90. Vacuum Lines

100. Upper Shutoff Valve

110. Lower Shutoff Valve

120. Fluid Outlet

The invention will be understood clearly when it is explained with the reference numbers mentioned above and with reference to the attached drawings.

### DETAILED DESCRIPTION

Said invention is related to a free flow electronic meter which is used in measuring the velocity and flow rate of the fluid; particularly in measuring milk yields of both small ruminants and cattle dairy farming enterprises.

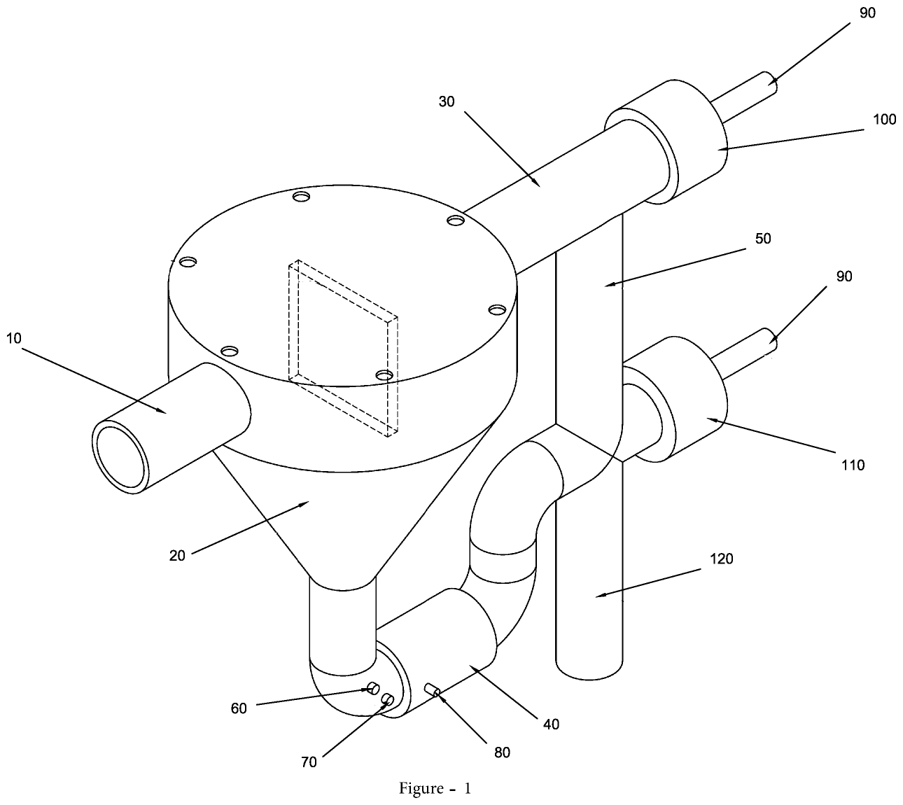

In FIG. 1, the free flow electronic meter of the present invention is shown. The new meter in the invention consists of two circular pipes, continuous air passage pipe (30) and milk measurement pipe (40). The milked milk enters through inlet (10) into a front collection chamber (20). While the milk flows fully through the measurement pipe (40), the continuous air passage pipe (30) and/or free air passage pipe (50) provides vacuum; thus, the vacuum level at the teats does not change due to the increased milk flow rate during milking and the vacuum fluctuation does not happen, which otherwise would cause udder diseases.

There is a height difference between the milk inlet (10) level and outlet level of the measurement pipe (40) and the outlet port of the measurement pipe (40) is at least as wide as the diameter of the measurement pipe (40). Therefore, in accordance with the principal of computational fluid, in the measurement pipe (40) the flow shall be in the direction of discharge after it is fully filled. When the material flows fully through the measurement pipe (40), the velocity of the flowing material can be measured by means of the flow rate sensor (80) on the measurement pipe (40). Because the diameter in the measurement pipe (40), where the milk enters first, is constant, the velocity of the fluid due to increased pressure at the inlet of the measurement pipe (40) will increase. Similarly, when the milked milk amount decreases, the level in the first front collection chamber (20) and thus the pressure, decreases; accordingly, the velocity of the fluid will decrease also. The milk amount during the milking process can be measured without a mistake by means of the flow rate obtained as a result of multiplying the constant cross-sectional area and the velocity.

During the milking process, the electrical conductivity is measured without a mistake by means of the electrical conductivity sensor (70), in order to determine udder diseases as the milk which passes through the measurement pipe (40) will be foamless. Therefore, the meter both measures the milk productivity with a very little margin of error and also makes electrical conductivity measurements which is used for making early diagnosis of udder diseases. Thus, this data, together with the milk measurement data, will be transmitted to the herd management software.

There are lower (110) and upper (100) shutoff valves which cuts the connection of both the air passage pipe (30) and the measurement pipe (40) with the vacuum lines (90) on the meter. These valves provide the milking cluster to be removed from the udder in an easy manner with the automatic remover by cutting all vacuum feedings at the end of the milking process. Therefore, a further vacuum cutter valve group is not required for the automatic remover assembly.

The milk meter is washed together with the milking system at the end of each milking process. During the washing process, in order to wash all surfaces of the meter body in a proper manner for said vacuum cutting, the lower (110) and the upper (100) valves are opened and closed respectively in predetermined intervals. Therefore, the washing solution passes through the air passage pipe (30) and milk measurement pipe (40) and all surfaces of the front collection chamber (20) are washed fully.

During the washing process, the amount of the washing solution, the density of the solution conductivity and temperature of the solution—which is passing through the measurement pipe (40)—are measured and outputted to the software by means of the fluid flow rate measurement sensor (80), the conductivity measurement sensor (70) and the temperature measurement sensor (60) included within the measurement pipe (40). Therefore, monitoring whether all milk meters are washed with a sufficient quality. In other words, whether they are washed with a sufficient duration and at sufficient temperatures. If there are any meters which have shifted, the user will be warned. In such case, the affected meter will be pointed for the user in order to eliminate possible washing system failures.

As long as there is an explicit elevation difference between the inlet and outlet of the measurement pipe (40), it can make a proper measurement, and it will have more tolerance to balance position of the meter. Moreover, this milk meter can not only be used in the milking operations but it can also be used in bucket/mobile milking machines which are used in poor surfaces.

Alternatively, the measurement can be made not only by means of thermal, coriolis, magnetic, ultrasonic, vortex sensors but also by paddle meters because only milk will flow through the measurement pipe (40) without air interference.

The protection scope of the present invention is defined in the claims and cannot be limited with the above descriptions which are made only for illustrative purposes, it is clear that a person qualified in the art will be able to present the novelty presented with the invention by means of similar embodiments and/or will be able to apply this in the other areas with similar aims used within the relevant art. Therefore, it is explicit that such embodiments will lack novelty and particularly the inventive step criteria.

1) A free flow electronic meter, comprising:
at least one measurement pipe;
at least one air passage pipe;
at least one free air passage pipe; and
the at least one measurement pipe is connected to the at least one air passage pipe and/or at least one free air passage pipe.

2) The free flow electronic meter of claim 1, further comprising a flow rate measurement sensor, located on the measurement pipe.

3) The free flow electronic meter of claim 1, further comprising a front collection chamber, wherein the milk is collected when it first enters.

4) The free flow electronic meter of claim 1, further comprising an electrical conductivity sensor, located on the measurement pipe.

5) (canceled)

6) The free flow electronic meter of claim 1, further comprising a lower shutoff and/or an upper shutoff valves, wherein the lower shutoff valve is located on the lower end of the measurement pipe, while the upper shutoff valve is located on the air passage pipe.

7) The free flow electronic meter of claim 1, further comprising a temperature measurement sensor, located on the measurement pipe.
